(19) United States
(12) Patent Application Publication
(10) Pub. No.: US 2024/0418196 A1
(43) Pub. Date: Dec. 19, 2024

(54) SYSTEMS AND METHODS WITH LATTICE STRUCTURES FOR JOINING PARTS

(71) Applicant: GM GLOBAL TECHNOLOGY OPERATIONS LLC, Detroit, MI (US)

(72) Inventors: Stanley Tong, Royal Oak, MI (US); Daniel Peter Schuller, Royal Oak, MI (US)

(73) Assignee: GM GLOBAL TECHNOLOGY OPERATIONS LLC, Detroit, MI (US)

(21) Appl. No.: 18/335,352

(22) Filed: Jun. 15, 2023

(51) Int. Cl. F16B 15/00; B27F 7/17

(52) U.S. Cl. CPC F16B 15/0015; B29C 65/34; B29C 65/344; B29C 65/224

(57) ABSTRACT

Systems and methods for securing a product joint with a lattice structure. A system includes at least one fabricating system to create a connector with the lattice structure. A force system applies a force to the connector so that a material of the product flows into the lattice structure interweaving the material with the lattice structure to secure the joint by the lattice structure.

### INTRODUCTION

The present disclosure relates to manufacturing systems and methods for securing one part of a product to another part of the product, and more particularly relates to using lattice structures to securely connect two parts together.

The strength of the connection between two components of a product is important when the product is subjected to various forces and stresses. Various approaches are available to secure a joint including welding, gluing, fastening, etc. Some types of joints may be created quickly and efficiently. For example, hot stapling one part of the product to another part of the product may be quick but relies on a limited staple/part interaction to hold the two component parts together.

Various types of manufacturing processes exist to create or modify products. Printing technologies have come into widespread use due to their desirable qualities such as efficiency and flexibility. Various types of 3D printing technologies have been developed for creating objects from metal, ceramic and polymer materials. The various 3D printing technologies each generally includes a build surface, a material delivery system, an energy delivery system, and a control system. The build surface provides a reference surface upon which the material is deposited, layer-by-layer to successively build up the part according to design details. The material delivery system performs the depositing of a feedstock material, such as in a particle, fiber, or filament form, for fusing with the previously deposited layer. The energy delivery system adds energy to the feedstock material before, during and/or after deposition for liquifying/fusing the material into the part being created. The control system operates each of the other systems in building the object being created, such as according to math data definition.

Both traditional manufacturing processes and printing processes may be used in a variety of applications to achieve desired results. However, improving the strength of the interface between two parts of a component with a mechanism that connects one part relative to another part remains an objective.

Accordingly, it is desirable to provide improved methods and systems for securing one part to another part. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for securing a product joint with a lattice structure. A system includes at least one fabricating system to create a connector with the lattice structure. A force system applies a force to the connector so that a material of the product flows into the lattice structure interweaving the material with the lattice structure to secure the joint by the lattice structure.

In additional embodiments, the lattice structure is embodied as a series of cells. Each cell is formed by a number of structural members that connect and that define open spaces between the structural members.

In additional embodiments, the product includes two parts that mate with one another at the joint.

In additional embodiments, the lattice structure includes a number of interconnecting structural members, and the material is embodied as a number of elements extending through open spaces defined by the number of interconnecting structural members.

In additional embodiments, the lattice structure includes a number of structural members that connect and that define open spaces between the structural members, wherein the material completely fills the open spaces.

In additional embodiments, the lattice structure includes a series of plates joined together at lines forming a diamond pattern.

In additional embodiments, the lattice structure is embodied as a hot staple.

In additional embodiments, a heating system is included to heat the connector.

In additional embodiments, the joint has a geometry along the joint and the lattice structure matches the geometry.

In additional embodiments, the lattice structure defines open spaces, and the lattice structure is designed to maximize permeation of the material into the open spaces.

In a number of other embodiments, a method for securing a product includes creating, by at least one fabricating system, a connector with a lattice structure. A force system applies a force to the connector and the product, so that a material of the product flows into the lattice structure interweaving the material with the lattice structure to secure the joint by the lattice structure.

In additional embodiments, the lattice structure is formed as a series of cells. Each cell has a number of structural members that connect and that define open spaces between the structural members.

In additional embodiments, the product is produced from two parts. The parts are mated together at the joint.

In additional embodiments, the lattice structure is formed as a number of interconnecting structural members. The material is forced into the lattice structure to be embodied as a number of elements extending through the number of interconnecting structural members.

In additional embodiments, the lattice structure is formed as a number of structural members that connect and that define open spaces between the structural members. The open spaces are completely with the material.

In additional embodiments, the lattice structure is formed as a series of plates joined together at lines in a diamond pattern.

In additional embodiments, the lattice structure is embodied as a hot staple.

In additional embodiments, a heating system heats the connector.

In additional embodiments, the lattice structure is formed to match a geometry of the joint.

In a number of additional embodiments, a product includes one or more parts defining a joint. A connector with a lattice structure is disposed in the joint, with a material of the part or parts interweaved with the lattice structure so that the joint is secured by the lattice structure.

### DESCRIPTION OF THE DRAWINGS

The present disclosure will hereinafter be described in conjunction with the following drawing figures, wherein like numerals denote like elements, and wherein:

FIG. 1 is a schematic diagram of a manufacturing system in the process of building a product, in accordance with various embodiments;

FIG. 2 is a schematic diagram of a lattice structure cell produced as part of the manufacturing system of FIG. 1, in accordance with various embodiments:

FIG. 3 is a schematic diagram of a lattice structure with plural cells produced as part of the manufacturing system of FIG. 1, in accordance with various embodiments:

FIG. 4 is a schematic force diagram of a part of the lattice structure of FIG. 3 connecting two parts, in accordance with various embodiments; and

FIG. 5 is a flow chart of process for manufacturing a product using the system of FIG. 1 and the lattice structure of FIGS. 2 and 3, in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding introduction, summary or this detailed description.

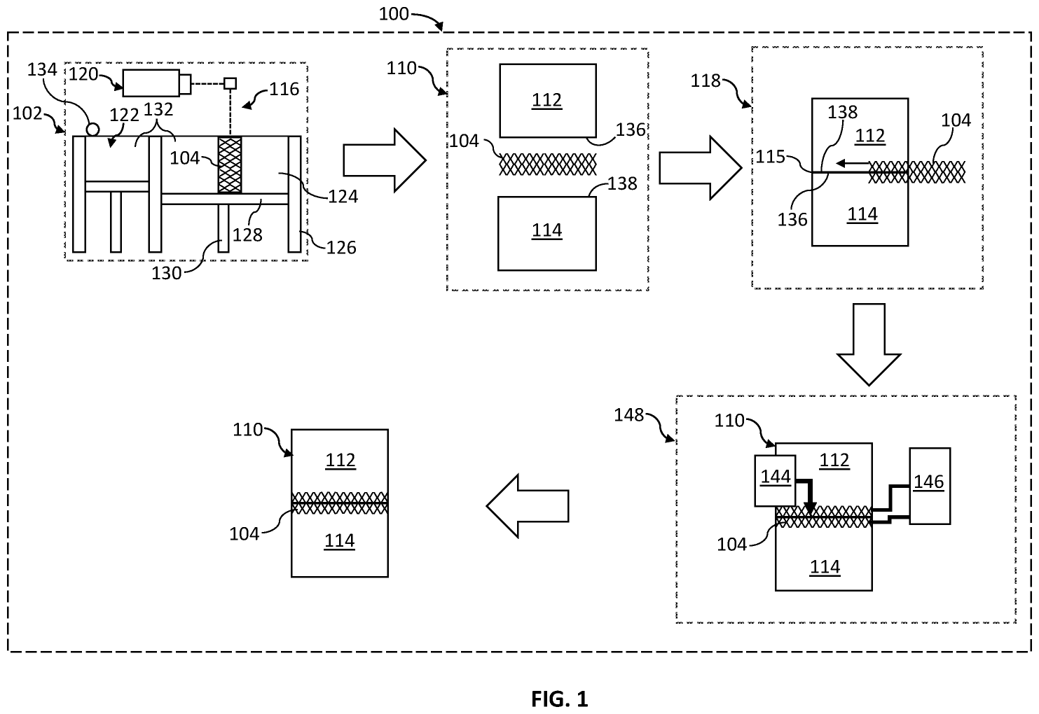

Referring to FIG. 1, a manufacturing system 100, is schematically illustrated. In general, the manufacturing system 100 includes a fabricating system 102, a connector 104, and a product 110, which includes a workpiece or workpieces in the form of the connector 104 and at least one part, in this example two parts 112, 114, to be connected with the connector 104. The fabricating system 102 may be any of a variety of object creation systems that may operate to create or modify a workpiece, that in the current embodiment is the connector 104, or at least a part thereof, the part 112, and/or the part 114. The fabricating system 102 may employ one or more of any of a variety of operations such as machining, casting, molding, shaping, deforming, bending, piercing, drilling, stamping, cutting, additive manufacturing, 3D printing, etc. In the current embodiment the fabricating system 102 includes a printing system 116, such as a laser powder bed fusion based machine. In other embodiments, another printing technology may be used such as binder jetting, powder bed fusion with electron beam, material extrusion/FDM, high-speed sintering, selective laser sintering, multi-jet fusion, or another printing technology.

In embodiments, the printing system 116 includes an energy delivery system in the form of an energy source 120, which may be of the heat producing type, a material deposition system in the form of a material depositor 122, a build chamber 124 defined by a build box 126, and a build platform 128 with an elevator 130. In a number of embodiments, a gas delivery system (not shown), may be included for delivery of an inert gas to the build chamber 124 to provide a favorable environment for the build. The material depositor 122 may be any mechanism to distribute a material 132, from which the connector 104 and/or the parts 112, 114 is/are formed, such as a roller, brush, blade, spreader, sprayer, feeder, or others.

In the current embodiment, the printing system 116 is illustrated as employing a powder bed fusion type additive manufacturing/3D printing technology to create the connector 104. In other embodiments, the additive manufacturing cell 100 may be configured for or another type of additive manufacturing. It will be appreciated that the connector 104 and the parts 112, 114 being printed may be built of a material that is, or includes, one or more of a metal, a ceramic, a polymer, or other material. For example, the parts 112, 114 may be made of a polymer that may be molded or otherwise formed, and the connector 104 may be made of a metal.

Accordingly, the selected fabricating system 102, which may include a 3D printing approach or approaches, may be tailored to the material(s) selected for forming the connector 104 and the parts 112, 114. In other embodiments, additive manufacturing may not be used, or may be used only in part, and conventional machining/forming technologies may be employed. For example, the connector 104 and/or parts of the connector 104, may be created by any material forming operations.

In the current embodiment, the printing system 116 is configured for the application of a powder form of the material 132 by the material depositor 122. The melting/fusing of the material 132 is selectively performed by the energy source 120 via a controlled exposure. The material 132 is applied by a spreader 134 of the material depositor 122 in a series of successive layers onto the build platform 128. The connector 104, and or the parts 112, 114 is/are successively built up in layers on the build platform 128, which moves during the build via the elevator 130. When the forming process for a given layer is completed, the build platform 128 may be lowered by the amount of the layer thickness and the next material layer may be applied. This process is repeated until the entire design geometry of the workpiece, or the designated part thereof, is generated.

In various embodiments, the workpiece(s), such as the connector 104 and/or the parts 112, 114 that is/are being built by the fabricating system 102 (in the current embodiment the printing system 116) may be a part of another product 110 that may include other physical parts. The connector 104 part of the product 110 may be referred to as a “staple” because it is formed and then is interacted with another part or parts 112, 114 of the product 110. The connector 104 includes, or is embodied as, a lattice structure 140. In some embodiments, the lattice structure 140 may extend completely through connector 104. In some embodiments, the lattice structure 140 may only exist on a part of the connector 104. In additional embodiments, the entire surface 142 of the connector 104 may include the lattice structure 140. In general, the lattice structure 140 may be included on any area of the connector 104 where coupling with another part, such as the parts 112, 114, is desired.

As shown in FIG. 1, the fabricating system 102 may be employed to produce the connector 104, the part 112, and/or the part 114. The part or parts 112, 114 have a joint 115 intended to be connected together, where an edge 136 of the part 112 is fixed in place relative to an edge 138 of the part 114. The parts 112, 114 are positioned, such as in a fixture station 118, so that the edges 136, 138 are disposed adjacent or against one another. In some examples, the edges 136, 138 may overlap. The connector 104 is moved into position to be disposed over the joint 115. In a stapling station 148, pressure, such as by a force system 144 and/or heat, such as by a heating system 146, are applied to the connector 104 and it is embedded into the part or parts 112, 114. As a result, the joint 115 is secured and the part or parts 112, 114 are secured together.

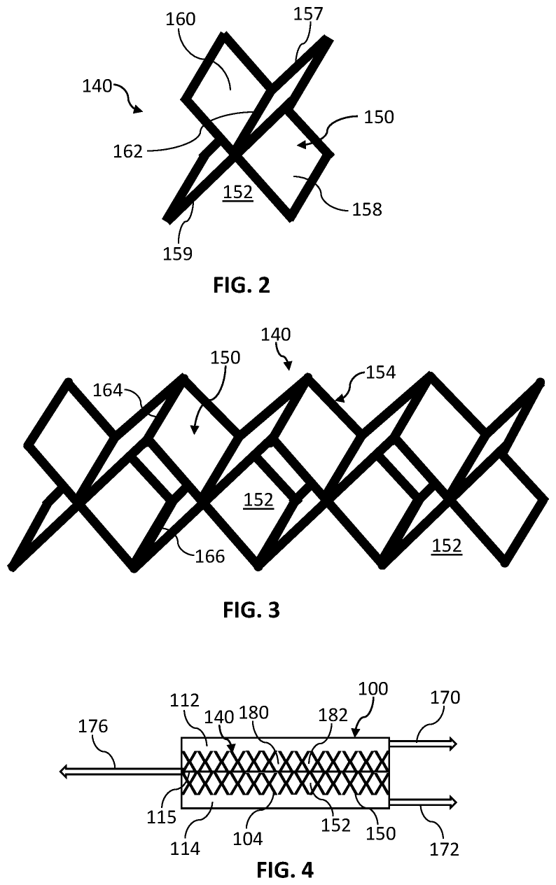

Referring to FIG. 2 and FIG. 3, along with FIG. 1, the lattice structure 140 will be described in more detail. In general, the lattice structure 140 includes an architecture with components referred to as structural members 150 that interconnect with one another to define spaces 152, that are open between the structural members 150 in two or three dimensions, or in what some may refer to as 2.5 dimensions. The structural members 150 are in general, physical, load carrying parts of the lattice structure 140. The lattice structure 140 may fill a volume, such as of the connector 104, or may conform to a surface, such as the surface 142 of the connector 104. In embodiments where the lattice structure 140 is only on the surface 142, the connector may have a solid center, or an open center. The lattice structure 140 may be a configuration based on repeating unit cells 154 composed of either specific shapes or random patterns in a web of any level of intricacy or simplicity. The repeating unit cells 154 may have any physical size tailored to the application. The lattice structure 140 may be periodic, non-periodic or random. In general, the lattice structure 140 includes the structural members 150 in any shape to define the open spaces 152 for receipt of an intervening material.

The lattice structure 140 may be cellular, with one cell 154 illustrated in FIG. 2 and four interconnected cells 154 shown in FIG. 3. In this example the cells 154 are X-shaped, or what may be referred to as diamond shaped when additional rows are added. Each cell 154 has four structural members 150, designated as members 157-160. Each of the members 157-160) is formed as a plate and the members 157-160 of the one cell 154 connect at a line 162. In other embodiments, the members 157-160 may be beams, surfaces, plates, trusses, cells, webs, nodes, struts, that fit together following an ordered, repeating, or random pattern. The members 157-160 may be interlocking, interwoven, interlinked, or otherwise interconnected patterns of material to form the lattice structure 140. In other embodiments, rather than being X/diamond shaped, the cells 154 may be triangular, star, octet, hexagonal, diamond, tetrahedron, gyroid, pyramid, body centered cubic, spiral, or in any configuration that includes members, such as the structural members 150 and that defines open spaces, such as the spaces 152. In the series of cells 154 illustrated in FIG. 3, each cell 154 connects with its neighboring cell 154 at two lines, for example the lines 164, 166. One horizontal row of cells 154 is illustrated in FIG. 3, however the cells may be arranged in any number of rows, columns, and depths in three dimensions.

Referring again to FIG. 1, the parts 112, 114 and the connector 104 are formed by the fabricating system 102 for the purposes of the application within which they will perform. In the current embodiment, the parts 112, 114 are panels made of a polymer. The joint 115 is designed to be fixed by means of a “hot staple” in the form of the connector 104. Because the connector 104 has the lattice structure 140, it fully integrates into the material of the parts 112, 114 when heat and/or pressure are applied. In embodiments, the force system 144 may be a mechanical, electrical, pneumatic and/or hydraulic device such as a press, a clamp, a gun, a weight, or any device configured to apply pressure to the connector 104 to drive it into the material of the parts 112, 114. The force system 144 may be used alone, or in combination with the heating system 146. The heating system 146 may be any system that heats the connector 104, such as an electrical, gas, ultrasonic, laser, and/or other heat producing/inducing device.

Referring to FIG. 4, during the coupling, the connector 104 is embedded into the material 180 of the parts 112, 114 and/or the material 180 flows around the structural members 150 into the spaces 152 and the material 180 forms elements 182 that fill the spaces 152. The flow of the material 180 fully impregnates the spaces 152 of the lattice structure 140 with the elements 182 interweaving with the structural members 150. After coupling the material 180 solidifies in the spaces 152 as the elements 182 lock the connector 104 to the parts 112, 114. At least some of the elements 182 may be completely separated from the other material 180 of the respective part 112, 114 an embedded in the lattice structure 140. As a result, in addition to surface level interaction, full integration and interaction of the material 180 of the parts 112, 114 with the lattice structure 140 results.

In a non-lattice hot-staple type process where a staple is placed into another part with piercing level interaction, only a limited number of penetration points may hold two parts together. Friction force (F_{f}) is a function of the applicable coefficient of friction (μ) and normal forces (F_{N}), which may be represented by the relation F_{f}=μF_{N}. Friction force tends to be low between typical hot stapled parts as retention is primarily provided by the staples themselves. For example, when the forces applied between the hot stapled parts reach a slip threshold, they will move relative to one another. Where that movement is unwanted, it may be described as a failure of the involved product.

In embodiments, adhesion force (Fₐ) may also apply, depending on the materials used. Adhesion force is proportional to contact surface area (A), which may be represented by the relation F∝A. Adhesion occurs between two surfaces by bonding, which arises through a chemical action, such as when the chains of two polymers interlink, or where the materials experience another form of chemical reaction. With typical hot stapled parts, such as a polymer parts and metal staples, adhesion force is low. As a result, the sum of friction force and adhesions force delivers only a modest amount of force carrying capability.

In the current embodiment where full interaction of the material 180 with the lattice structure 140 occurs between the structural members 150 and the elements 182, the material of the parts 112, 114 is interweaved with the material of the connector 104. As a result, rather than relying on surface level friction/adhesion to hold the product 110 together, a large number of structural members 150 and elements 182 secure the product 110. The relative part forces 170, 172 and the connector force 176 are carried by a large number of structural members 152 and elements 182. Shear/tensile strength comes into play in retaining the parts 112, 114 in place relative to the connector 104. Any forces applied between the connector 104 and the parts 112, 114 are distributed over a large number of sites (the structural members 150) and the elements 182), and the average stresses on the material per unit area are low. This is because stress (σ) is a function of force (I) and area (A), where σ=F/A. Because in the current embodiment the total area is large due to the sum of all the structural members 150 and/or the elements 182, the average stress is relatively low, and product failure is avoided over a large bandwidth of stress.

As shown in FIG. 4, when stress is created between the components of the product 100 (the connector 104 and the parts 112, 114), the sum of the forces 170, 172 on the parts 112, 114 is offset by the sum of the forces 176 on the connector 104. Because the forces 170, 172, 176 are carried by the sum of all the areas of the structural members 150 and the elements 182 they are distributed over a large number of areas. The large number of areas results in a large total area on which the force is applied, resulting in low stress at each site in a two-three dimensional space. In embodiments where the material 180, has a lower strength than the material of the connector 104, the spaces 152 may be designed substantially larger than the cross sectional area of the structural members 150. As a result, the stress on the material 180 in any of the given spaces 152 is low and the parts 112, 114 are secured by the connector 104 in an optimal way. In addition, because friction and adhesion strength is a function of surface area, the amount of force that the interface between the connector 104 and the parts 112, 114 is able to carry is also increased from the friction and adhesion perspective.

For example, friction/adhesion strength between the connector 104 and the parts 112, 114 may be optimized. Through physical, structural interference due to the lattice structure 140) and the interweaved material 180 between the connector 104 and the parts 112, 114, significantly higher normal forces are sustainable at the interface. In addition, the interweaved character of the connector 104 and the parts 112, 114 through the lattice structure 140 results in higher contact surface area and a higher load carrying capability due to friction and adhesion. In sum, the load carrying ability of the product 110 between the connector 104 and the parts 112, 114 is increased in three ways, including higher shear/tensile strength, higher friction strength and higher adhesion strength.

Referring again to FIG. 1, the product 110 leaving the forming system 108 includes the connector 104 with the parts 112, 114 fully integrated together. In addition to surface level interaction, there is a full interaction and integration of the connector 104 and the parts 112, 114 because the material 180 flows through the lattice structure 140 impregnating, touching, and bonding with, the entire lattice structure 140. The geometry of the lattice structure 140 with the spaces 152 enables the material 180 to flow through and interact with the structural members 150. The lattice structure 140 is configured to maximize permeation of the material 180 into the open spaces 152. The strength of the connection is not limited to the friction and shear force of the connection but also includes the area of the material 180 in the spaces 152 that distributes the forces/stress across multiple pieces with an equivalent cross sectional area that is very large relative to the surface interface between the connector 104 and the parts 112, 114.

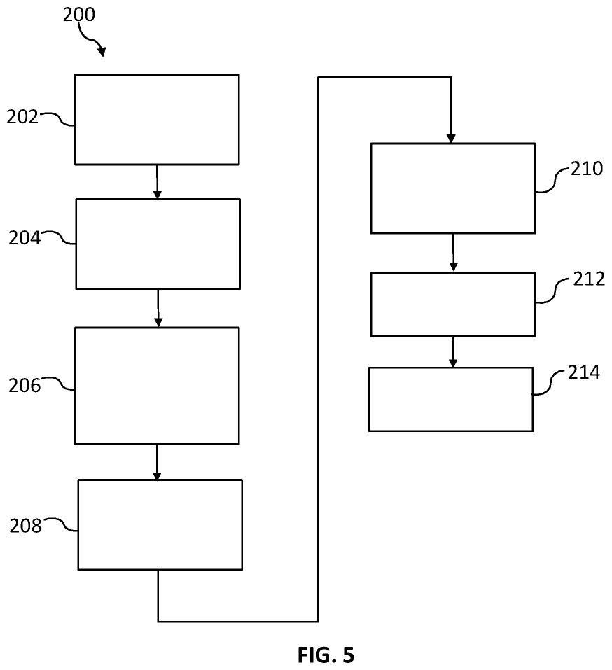

Referring to FIG. 5, a method 200 is illustrated for connecting components (such as the connector 104 and the parts 112, 114) with lattice structures, such as in stapling operations. As will be appreciated in light of the disclosure, the order of operation within the method 200 is not limited to the sequential execution as illustrated in FIG. 5 but may be performed in one or more varying orders as applicable and in accordance with the present disclosure. The method 200 starts when an item, such as the product 110, is designed 202. The product 110 may include a connector 104, or plural connectors 104, designed 202 for securing a part or parts, such as the parts 112, 114 together. The connector 104 may be a structural item, such as a staple. In general, the part(s) 112, 114 is/are designed to be mated/connected with one or more connectors 104. In some embodiments, the part(s) 112, 114 may be designed for application without the connectors 104, and one or more of the connectors 104 may be used to repair the part(s) 112, 114. The connector 104 and the parts 112, 114 may be composed of any materials, whether common or different from one another. In embodiments, the joint 115 has a defined geometry in three dimensions and the lattice structure 140 has a shape to match the defined geometry. For example, a custom connector 104 with lattice structure 140 may be created, such as by additive manufacturing to match the part geometry, such as for joining along a split in the part(s) 112, 114.

In sum, the connector 104 and the parts 112, 114 may be designed 202 to be connected together to form one product, such as the product 110, or to form a product from the part(s) 112, 114 that may be repaired after field use with the connector(s) 104. Following the step of being designed 202, the connector 104 may be fabricated 204, such as by the fabricating system 102. The part(s) 112, 114 are also created the connector 104 may be fabricated 204, such as by the fabricating system 102. In an example, the part(s) 112, 114 may be molded, such as of a polymer or polymers. In another example, the part(s) 112, 114 may be made of glass.

The connector 104 is fabricated 204 with at least one section that includes a lattice, such as the lattice structure 140. The connector 104 may be fabricated 204 by any means that results in the connector 104 with the lattice structure 140. As fabricated 204, the connector 104 includes one or more areas of the lattice structure 140. The lattice structure 140 is configured to be formed by the fabricating system 102. As part of the step of being designed 202, the details of the lattice structure 140 may be generated in a computer aided design (CAD) system and may be tuned. Properties of the lattice structure 140 (mechanical, thermal, etc.) are determined by lattice type and other design parameters such as unit cell size and thickness of members. The lattice structure 140 is optimized to maximize strength (shear/tensile and adhesion/friction), to address deformation mechanisms, to maximize surface area, to optimize cell size and density, to optimize thickness of members, cell orientation and other parameters.

The method 200 proceeds by positioning 206 the connector 104 over the area to be joined, such as at the joint 115. The force system 144 is operated to force 208 the connector into the part(s) 112, 114 at the joint 115. The force system 144 may be used alone, or in combination with the heating system 146. The heating system 146 may be used to heat 210 the connector 104, prior to, or after applying the force 208, to a temperature above the melting point of the material 180 of the part(s) 112, 114. In some embodiments, the joint 115 may be secured first, such as by an adhesive, and the lattice structure 140 of the connector 104 may be added to enhance the joint connection with better permeation and joint strength.

The connector 104 is forced 208 into the material 180, such as by a press as the force system. The material 180 flows around the structural members 150 and into the spaces 152. The lattice structure 140, such as by part of the step of being designed 202, may be configured to optimize flow of the material 180 into the spaces 152. Behavior of the material 180, under action of the force 208 and/or the heat 210, may be considered as that of a liquid. The CAD system employed may use available fluid dynamics modelling software to consider the rheology including the direction of flow of the material 180, the temperatures of the connector 104, the applied force 208, surface interaction between the involved materials, and any other governing parameters to ensure complete integration of the material 180 into the lattice structure 140. In specific examples, the size of the structural members 150 may be increased to conduct more heat and increase the flow of the material 180 into the lattice structure 140. In some embodiments the spaces 152 may be tapered. For example, as the material 180 moves through the lattice structure 140, the size of the areas 152 for open flow may change to maintain flow (e.g., downstream areas 152 are smaller or larger than upstream areas 152). The design ensures the material 180 completely fills the open areas 152.

With the material 180 fully integrated with the lattice structure 140, the heat 210 and the force 208 are stopped 212. As the material 180 solidifies, it locks the part(s) 112, 114 in position by the connector 104. The solid form of the material 180 then exists within the lattice structure 140. The method 200 ends 214 with the part(s) 112, 114 secured at the joint 115.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for securing a product at a joint, the system comprising:
at least one fabricating system configured to create a connector with a lattice structure;
a force system configured to apply a force to the connector and the product, so that a material of the product flows into the lattice structure interweaving the material with the lattice structure to secure the joint by the lattice structure.

2. The system of claim 1, wherein the lattice structure comprises a series of cells, wherein each cell is formed by a number of structural members that connect and that define open spaces between the structural members.

3. The system of claim 1, wherein the product comprises a first part and a second part, wherein the first part mates with the second part at the joint.

4. The system of claim 1, wherein the lattice structure comprises a number of interconnecting structural members and the material comprises a number of elements extending through open spaces defined by the number of interconnecting structural members.

5. The system of claim 1, wherein the lattice structure comprises a number of structural members that connect and that define open spaces between the structural members, wherein the material completely fills the open spaces.

6. The system of claim 1, wherein the lattice structure comprises a series of plates joined together at lines forming a diamond pattern.

7. The system of claim 1, wherein the lattice structure comprises a hot staple.

8. The system of claim 1, comprising a heating system configured to heat the connector.

9. The system of claim 1, wherein the joint comprises a geometry along the joint and the lattice structure matches the geometry.

10. The system of claim 1, wherein the lattice structure defines open spaces and wherein the lattice structure is configured to maximize permeation of the material into the open spaces.

11. A method for securing a product, the method comprising:
creating, by at least one fabricating system, a connector with a lattice structure; and
applying, by a force system, a force to the connector and the product, so that a material of the product flows into the lattice structure interweaving the material with the lattice structure to secure the joint by the lattice structure.

12. The method of claim 11, comprising forming the lattice structure as a series of cells, wherein each cell has a number of structural members that connect and that define open spaces between the structural members.

13. The method of claim 11, comprising:
producing the product from a first part and a second part; and
mating the first part with the second part at the joint.

14. The method of claim 11, comprising forming the lattice structure as a number of interconnecting structural members; and
forcing the material into the lattice structure as a number of elements extending through open spaces defined by the number of interconnecting structural members.

15. The method of claim 11, comprising:
forming the lattice structure as a number of structural members that connect and that define open spaces between the structural members; and
filling the open spaces completely with the material.

16. The method of claim 11, comprising forming the lattice structure as a series of plates joined together at lines in a diamond pattern.

17. The method of claim 11, comprising configuring the lattice structure as a hot staple.

18. The method of claim 11, comprising heating, by a heating system, the connector.

19. The method of claim 11, comprising forming the lattice structure to match geometry of the joint.

20. A product, comprising:
at least one part defining a joint; and
a connector with a lattice structure disposed in the joint, with a material of the at least one part interweaved with the lattice structure so that the joint is secured by the lattice structure.
